(19) United States
(12) Patent Application Publication
(10) Pub. No.: US 2012/0235630 A1
(43) Pub. Date: Sep. 20, 2012

(54) CHARGING SYSTEM WITH ADAPTIVE POWER MANAGEMENT

(75) Inventors: Weihong Qiu, San Ramon, CA (US); Xiaozhou Zhou, Fremont, CA (US); Jun Liu, Sunnyvale, CA (US); Bertram J. Rodgers, III, San Francisco, CA (US)

(73) Assignee: INTERSIL AMERICAS LLC, Milpitas, CA (US)

(21) Appl. No.: 13/421,836

(22) Filed: Mar. 15, 2012

Related U.S. Application Data
(60) Provisional application No. 61/452,819, filed on Mar. 15, 2011.
(60) Provisional application No. 61/478,575, filed on Apr. 25, 2011.
(60) Provisional application No. 61/604,226, filed on Feb. 28, 2012.

(51) Int. Cl. H02J 7/00; H02M 7/02

(52) U.S. Cl. 320/107; 363/74

(57) ABSTRACT

An embodiment of a charger may include an input, at least one switch having a first node coupled to a reference voltage, a current sensor coupled between the input and a second node of the at least one switch, an output coupled to a third node of the at least one switch, and a charge controller coupled to the input to determine an input voltage, to the current sensor to determine an input current and to control inputs of the at least one switch. The at least one switch may be responsive to control signals supplied by the charge controller to the control inputs thereof to control voltage and current at the output of the charger. The charge controller may be responsive to the input voltage and the input current to produce the control signals in a manner that maximizes electrical power drawn at the input.

### CLAIM OF PRIORITY

This application claims the benefit of, and priority to, U.S. Provisional Patent Application Ser. No. 61/452,819, filed Mar. 15, 2011, U.S. Provisional Patent Application Ser. No. 61/478,575, filed Apr. 25, 2011, and U.S. Provisional Patent Application Ser. No. 61/604,226, filed Feb. 28, 2012 the disclosures of which are each incorporated herein by reference.

### BRIEF DESCRIPTION OF THE DRAWINGS

FIG. 1 is a diagram of an embodiment of a charging system with adaptive power management.

FIG. 2 is a diagram of an embodiment of the adaptive charge controller illustrated in FIG. 1.

FIG. 3 is a diagram of an embodiment of the adaptive power control unit illustrated in FIG. 2.

FIG. 4 is a plot of output voltage vs. output current illustrating power output characteristics of an example of the AC adapter of FIG. 1.

FIG. 5 is a plot of output power vs. output voltage of the AC adapter of FIGS. 1 and 4 illustrating the general operation of the APC unit of FIG. 3 in maximizing AC adapter output power according to an embodiment.

FIG. 6 is a flowchart of an embodiment of a process executed by the APM unit of FIG. 3, and by the IDPM unit of FIG. 3 and the PWM controller of FIG. 2, for maximizing output power produced by the AC adapter under certain operating conditions according to an embodiment.

FIG. 7 is a diagram of an embodiment of the adaptive power management unit of in FIG. 3.

FIG. 8 is a timing diagram of the operation of the adaptive power management unit of FIG. 5 in accordance with an implementation thereof.

### DESCRIPTION OF THE ILLUSTRATIVE EMBODIMENTS

For the purposes of promoting an understanding of the principles disclosed herein, reference will now be made to a number of embodiments.

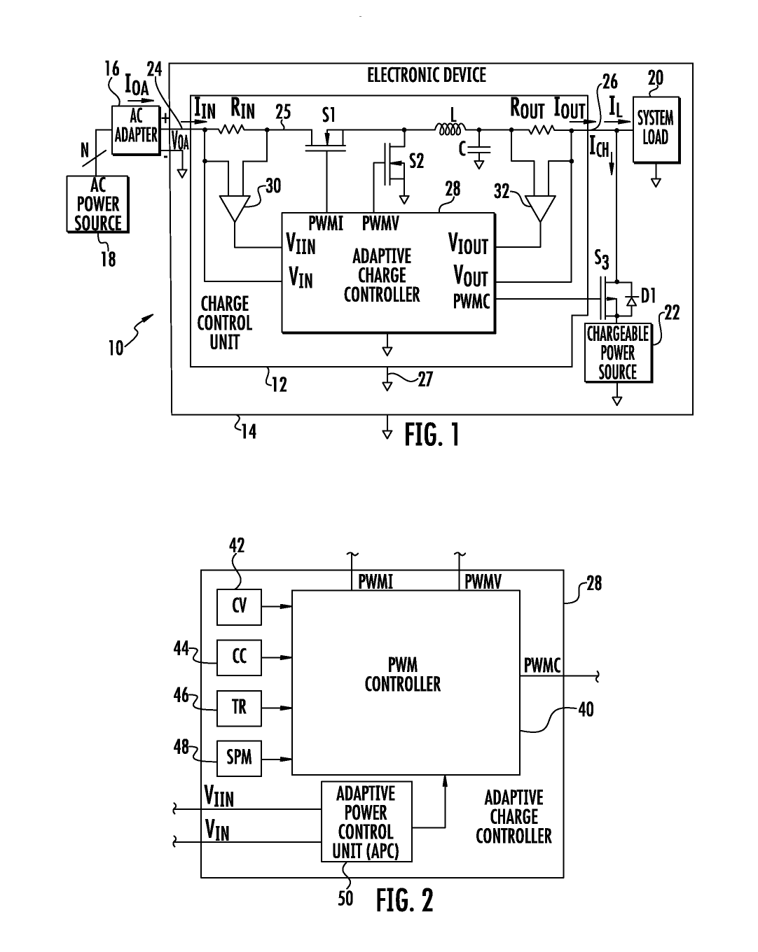

Referring now to FIG. 1, a diagram is shown of one embodiment of a charging system 10 with adaptive power management. The charging system 10 includes a charge-control unit 12, which controllably supplies DC voltage and current from an external power source to one or both of a chargeable power source and an electronic system or device. The external power source is provided in the form of a conventional AC adapter 16, which converts alternating current (AC) and voltage supplied by an AC power source 18 to a direct current, I_{OA}, (DC) and a DC voltage, V_{OA}. The AC power source 18 may be a conventional residential or commercial electrical service, a conventional generator, or the like. An input of the AC adapter 16 is electrically coupled to the AC power source 18 via a number, N, of separate electrical conductors, e.g., wires, where N may be any positive integer, and the output of the AC adapter 16 includes a DC positive (+) output and a DC reference (−) output.

In an embodiment, the charge-control unit 12 is implemented within, i.e., housed within, an electronic device 14, although this disclosure contemplates embodiments in which the charge-control unit 12 may be separate from, i.e., housed separately from and/or remote from, the electronic device 14. The electronic device 14 is, for example, a portable electronic device. Examples of the portable electronic device 14 may include, but are not limited to, a laptop or notebook computer, a tablet computer or other tablet device, a hand-held electronic device, a cellular telephone, and the like. In alternative embodiments, the electronic device 14 may be a non-portable electronic device. The electronic device 14 includes one or more electrical circuits and/or subsystems that consume electrical energy, and in FIG. 1 such one or more electrical circuits and/or subsystems is/are represented as a single system load 20. The electrical system 14 also includes a chargeable power source 22, which may be or include one or more conventional rechargeable batteries or battery cells, one or more capacitors, and/or the like. When the AC adapter 16 is electrically coupled between the AC power source 18 and the charge-control unit 12, the charge-control unit 12 is operable to controllably supply the DC voltage, V_{OA}, and the DC current, I_{OA}, produced by the AC adapter to the system load 20 and/or to the chargeable power source 22. When the AC adapter 16 is uncoupled from the charge control unit 12, the chargeable power source 22 supplies, via the diode D1, a DC voltage and any DC current required by the system load 20. The charge-control unit 12 may also turn on the device S3 during such conditions to improve the efficiency of current flow from the chargeable power source 22 to the system load 20.

The charge control unit 12 has an input 24 that is electrically coupled to one end of a supply line 25 and to the + output of the AC adapter 16The opposite end of the supply line 25 defines an output 26 of the charge control unit 12 that is electrically coupled to the system load 20. The “−” output of the AC adapter 16 is electrically coupled to a reference node 27 of the charge control unit 12. As used herein, the terms “reference voltage” and “reference node” refer to an electrical connection identified in the drawings by a down-arrow, which reference connection is maintained at a predefined reference potential. In an embodiment, the predefined reference potential (and therefore the reference voltage) is ground potential, although other predetermined reference potentials (and corresponding reference voltages) are contemplated by this disclosure. In an embodiment, the reference node 27 of the charge-control unit 12 is electrically coupled to the “−” output of the AC adapter 16 and also to the reference nodes of the system load 20, the chargeable power source 22, the electronic device 14, and adaptive charge controller 28.

The charge-control unit 12 also includes an adaptive charge controller 28 and switching circuitry in the form of one or more switches coupled in-line with the supply line 25 between the charge-control-unit input 24 and output 26. The switching circuitry is responsive to control signals produced by the adaptive charge controller 28 to controllably supply voltage and current to the output 26 of the charge control circuit 12, e.g., to the system load 20. In the embodiment illustrated in FIG. 1, for example, the switching circuitry includes a pair of switches S1 and S2. Control inputs of the pair of switches S1 and S2 are electrically coupled to control outputs of the adaptive charge controller 28. For example, a pulse-width-modulated current-control output, PWMI, of the adaptive charge controller 28 is electrically coupled to the control input of the switch S1, and a pulse-width-modulated voltage-control output, PWMV, of the adaptive charge controller 28 is electrically coupled to the control input of the switch S2.

One node of the pair of switches, i.e., the output of the switch S2, is electrically coupled to the reference voltage, and another node, i.e., the signal input of the switch S1, is electrically coupled through a resistor R_{IN} disposed in-line (i.e., series-coupled) with the supply line 25 to the input 24 of the charge control unit 12. Another node of the pair of switches, i.e., the connection of the output of the switch S1 and the signal input of the switch S2, is electrically coupled through a series combination of an inductor L disposed in-line (i.e., series-connected) with the supply line 25 and another resistor R_{OUT} also disposed in-line (i.e., series-connected) with the supply line 25 to the output 26 of the charge control unit 12. The inductor L is positioned between the resistor R_{OUT} and the common connection of the output of the switch S1 and the input of the switch S2, and a capacitor C is electrically coupled at one end to the reference voltage and at an opposite end to the common connection of the inductor L and the resistor R_{OUT}. Together the inductor, L, and the capacitor, C, make up a conventional low-pass filter circuit used in the charge-control unit 12 to filter out high-frequency effects that may be introduced onto the supply line 25 by switching of the switches S1 and/or S2. In some alternate embodiments, the inductor L and/or the capacitor C may be replaced by one or more other conventional electrical components to form a low-pass or other type of signal filtering circuit, and in other embodiments either or both of the inductor L and the capacitor C may be omitted from the charge control circuit 12.

The electronic device 14 includes a switching device S3 having one node, e.g., an input/output node, electrically coupled to the output 26 of the charge-control unit 12, another node, e.g., an input/output node, electrically coupled to one end of the chargeable power source 22, and a control input electrically coupled to a pulse-width-modulated charge output, PWMC, of the adaptive charge controller 28. In alternative embodiments, the switching device S3 may be included within the charge-control unit 12, and in any case the opposite end of the chargeable power source 22 is electrically coupled to the reference voltage. The adaptive charge controller 28 is operable, as will be described in greater detail hereinafter, to control the duty cycles of the control signals PWMI, PWMV, and PWMC applied to the switches S1-S3 respectively to control the magnitudes of the output current I_{OUT} and the output voltage V_{OUT} produced at the output 26 of the charge-control unit 12 and to control, e.g., partition, consumption of the output current I_{OUT} as between a load current I_{L} supplied to the system load 20 and a charge current I_{CH} supplied to the chargeable power source 22 under various operating conditions in which the AC adapter 16 is electrically coupled to the charge-control unit 12.

In the embodiment shown in FIG. 1, the switches S1 and S2 are implemented in the form of conventional N-channel metal-oxide-semiconductor field effect transistors (MOSFETs), and the switch S3 is implemented in the form of a conventional P-channel MOSFET. It will be understood, however, that any one or more of the switches S1-S3 may be alternatively be implemented in the form of one or more other conventional semiconductor-based devices or other switches.

The charge-control unit 12 further includes an input current sensor electrically coupled between the input 24 of the charge control unit 12 and the signal input of the switch S1, which operates to sense the input current I_{IN} of the charge control unit 12, which input current is also the output current I_{OA} produced by the AC adapter 16. In the illustrated embodiment, the input current sensor is implemented in the form of the combination of the resistor R_{IN} and a current sense amplifier 30 having one input electrically coupled to the common connection of the input 24 of the charge-control unit 12 and one end of the resistor R_{IN}, and another input electrically coupled to the common connection of the signal input of the switch S1 and the opposite end of the resistor R_{IN}. The output of the current-sense amplifier 30 is electrically coupled to an input-current input, V_{IIN}, of the adaptive charge controller 28. The output of the current-sense amplifier 30 produces the voltage, V_{IIN}, which is proportional to the input current I_{IN} supplied to the charge-control unit 12 by the AC adapter 16. The output voltage V_{OA} produced by the AC adapter 16 is the input voltage V_{IN} at the input 24 of the charge control unit 12, and the input 24 is electrically coupled to an input-voltage input, V_{IN}, of the adaptive charge controller 28. In alternative embodiments, one or more other conventional current and/or voltage sensors may be used to determine the input current and voltage respectively of the charge-control unit 12. In any case, signals corresponding to the DC current (I_{IN}) supplied to the charge-control unit 12 (which is, in the illustrated embodiment, the output current I_{OA} of the AC adapter 16) and the DC voltage (V_{IN}) supplied to the charge-control unit 12 (which is, in the illustrated embodiment, the output voltage V_{OA} of the AC adapter 16) are supplied as inputs to the adaptive charge controller 28. The charge-control unit 12 further includes an output-current sensor electrically coupled between the output 26 of the charge-control unit 12 and the output of the filter circuit (e.g., the output of the inductor L), which operates to sense the output current I_{OUT} produced by the charge control unit 12 (where I_{OUT} is the sum of the load current, I_{L}, consumed by the system load 20 and the charge current, I_{CH}, consumed by the chargeable power source 22). In the illustrated embodiment, the output-current sensor is implemented in the form of the combination of the resistor R_{OUT} and a current-sense amplifier 32 having one input electrically coupled to the common connection of the output 26 of the charge-control unit 12 and one end of the resistor R_{OUT}, and another input electrically coupled to the common connection of the input of the inductor L and the opposite end of the resistor R_{OUT}. The output of the current-sense amplifier 32 is electrically coupled to an output-current input, V_{IOUT}, of the adaptive charge controller 28, and the output of the current-sense amplifier 32 produces the voltage, V_{IOUT}, which is proportional to the output current I_{OUT} supplied by the charge-control unit 12. The output voltage V_{OUT} produced at the output 26 of the charge-control unit 12 is electrically coupled to an output voltage input, V_{OUT}, of the adaptive charge controller 28. In alternative embodiments, one or more other conventional current and/or voltage sensors may be used to determine the output current and voltage respectively of the charge-control unit 12. In any case, signals corresponding to the output current of the charge-control unit 12 and the output voltage of the charge-control unit 12 are supplied as inputs to the adaptive charge controller 28.

Referring now to FIG. 2, a diagram is shown of some of the components of the adaptive charge controller 28 illustrated in FIG. 1. In the embodiment illustrated in FIG. 2, the adaptive charge controller 28 includes a pulse-width-modulation (PWM) controller 40, which receives control signals from a number of mode control modules and produces the pulse-width-modulation (PWM) control signals PWMI and PWMV, which control the output current (I_{OUT}) and the output voltage (V_{OUT}), respectively supplied by the charge-control unit 12, and also produces the pulse-width-modulated (PWM) control signal PWMC which controls the amount or portion of the output current, I_{OUT}, supplied as the charge current, I_{CH}, to the chargeable power source 22. In the illustrated embodiment, the mode-control modules include, for example, a constant-voltage (CV) control module 42, a constant-current (CC) control module 44, a trickle-charge (TR) control module 46, a static-power-management (SPM) control module 48, and an adaptive-power-control (APC) module or unit 50. The adaptive charge controller 28 has a plurality of different operating modes each determined and controlled by a different one of the control modules 42-50 in response to one or more of the input current signal V_{IIN}, the input voltage V_{IN}, the output current signal, V_{IOUT} and the output voltage V_{OUT}. The constant voltage (CV) control module 42, for example, is responsive in a conventional manner to one or more of the input current signal V_{IIN}, the input voltage V_{IN}, the output current signal, V_{IOUT} and the output voltage V_{OUT} to produce control signals from which the PWM controller 40 controls the duty cycles of the control signals PWMI, PWMV and/or PWMC in a manner that causes the charge control unit 12 to produce the output current I_{OUT} at a constant output voltage V_{OUT}. The constant current (CC) control module 44 is responsive in a conventional manner to one or more of the input current signal V_{IIN}, the input voltage V_{IN}, the output current signal, V_{IOUT} and the output voltage V_{OUT} to produce control signals from which the PWM controller 40 controls the duty cycles of the control signals PWMI, PWMV and/or PWMC in a manner that causes the charge control unit 12 to produce a constant output current I_{OUT}. The trickle charge (TR) control module 46 is responsive in a conventional manner to one or more of the input current signal V_{IIN}, the input voltage V_{IN}, the output current signal, V_{IOUT} and the output voltage V_{OUT} to produce control signals from which the PWM controller 40 controls the duty cycles of the control signals PWMI, PWMV and/or PWMC in a manner that causes the charge control unit 12 to charge the chargeable power source 22 at a slow, controlled charging rate. The static power management (SPM) control module 48 is responsive in a conventional manner to one or more of the input current signal V_{IIN}, the input voltage V_{IN}, the output current signal, V_{IOUT} and the output voltage V_{OUT} to produce control signals from which the PWM controller 40 controls the duty cycles of the control signals PWMI, PWMV and/or PWMC in a manner that minimizes overshoot of the output current I_{OUT} during rapid transient charging events. The adaptive power control (APC) module or unit 50 is responsive to one or more of the input current signal V_{IIN}, the input voltage V_{IN}, the output current signal, V_{IOUT} and the output voltage V_{OUT}, as will be described in greater detail hereinafter, to produce control signals from which the PWM controller 40 controls the duty cycles of the control signals PWMI, PWMV and/or PWMC during certain operating conditions in which the output current, I_{OUT}, demanded by the combination of the system load 20 and the charge control unit 12 or by the combination of the system load 20, the chargeable power source 22 and the charge control unit 12, exceeds the available input current, I_{IN}, i.e., in which the demanded input current, I_{IN} (i.e., current demanded at the input 24 of the charge control unit 12), exceeds the output current, I_{OA}, that can be produced by the AC adapter 16. In all such operating modes, the PWM controller 40 is responsive to the control signals produced by the mode control units 42, 44, 46, 48 and 50 to control the duty cycles of the control signals PWMI, PWMV and/or PWMC in a conventional manner.

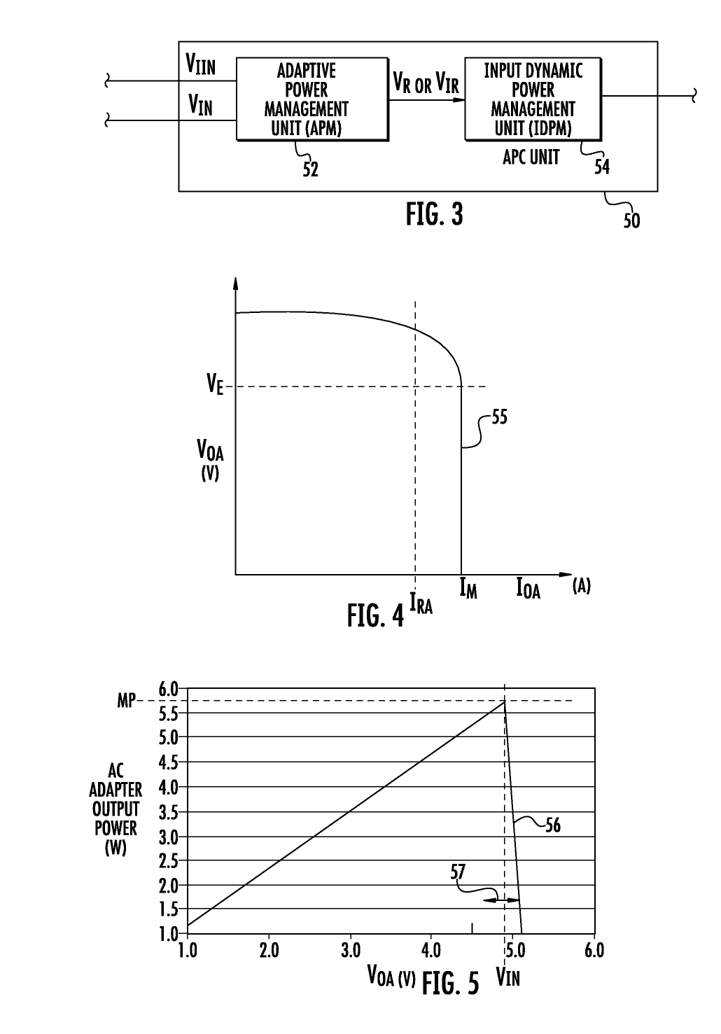

Referring to FIG. 3, one illustrative embodiment of the adaptive power control (APC) module or unit 50 is shown. In the illustrated embodiment, the adaptive power control (APC) module or unit 50 includes an adaptive power management (APM) unit 52 receiving as inputs the input voltage V_{IN} of the charge control unit 12 and the input current signal V_{IIN} of the charge control unit 12 (e.g., from the output of the current sense amplifier 30), wherein V_{IIN} and V_{IN} correspond to the output current, I_{OA}, and the output voltage, V_{OA}, respectively of the AC adapter 16. The APM unit 52 is operable, as will be described in greater detail hereinafter, to processes V_{IIN} and V_{IN} and to produce as an output a reference control signal in the form of a voltage reference control signal, V_{R}, or a current reference control signal, e.g., in the form of a voltage, V_{IR}. The reference control signal output of the APM unit 52 is provided as an input to a conventional input dynamic power management (IDPM) unit 54 that is responsive in a conventional manner to the reference control signal (V_{R} or V_{IR}) and to one or more of the output current signal V_{IOUT} and the output voltage V_{OUT} to produce the control signals from which the PWM controller 40 controls the duty cycle of the control signals PWMI, PWMV and/or PWMC in a manner that partitions the output current I_{OUT} into the load current, I_{L}, required by the system load 20 and the remaining charge current, I_{CH}, which is controllably applied (e.g., via control of the switch S3) to the chargeable power source 22 to recharge the source 22.

Referring now to FIG. 4, a plot is shown of the output voltage V_{OA} vs. the output current I_{OA} of one illustrative example of the AC adapter 16. In the illustrated example, the output voltage V_{OA} remains relatively constant as the output current I_{OA} increases from zero to a so-called rated current, I_{RA}. The rated current I_{RA} is generally understood to define a maximum output current I_{OA} of the AC adapter 16 below which V_{OA} remains relatively constant. As the output current I_{OA} increases above (i.e., greater than) I_{RA} toward an absolute maximum current, I_{M}, that can be supplied by the AC adapter 16, the output voltage, V_{OA}, drops sharply toward zero.

In some conventional charge control systems, the maximum output power produced by the AC adapter 16 when the input current I_{IN} demanded by the combination of the charge control unit 12 and the system load 20 or by the combination of the system load 20, the chargeable power source 22 and the charge control unit 12 exceeds that which can be produced by the AC adapter 16, is regulated at the output power that is produced when the output current, I_{OA}, produced by the AC adapter 16 reaches I_{RA} or some other static output current value. In other conventional charge control systems the maximum allowable output power produced by the AC adapter 16 under such conditions is regulated at the output power that is produced when the output voltage, V_{OA}, produced by the AC adapter 16 drops to some predefined static voltage value, V_{E}, after the output current I_{OA} reaches and increases beyond I_{RA}. In such conventional charge control systems which include an input dynamic power management unit, such as IDPM unit 54 for example, the output voltage, V_{OA}, is the reference control signal input to the IDPM unit, and the IDPM unit is configured to be activated when the output voltage, V_{OA}, produced by the AC adapter 16 drops below the predefined static voltage value, V_{E}. The PWM controller 40 is then responsive to control signals produced by the IDPM unit when V_{OA} drops below V_{E} to control PWMV such that the output voltage V_{OA} produced by the AC adapter 16 is maintained at the constant voltage V_{E}. The magnitude of the output current, I_{OA}, produced by the AC adapter 16 under such conditions, i.e., in which the input current I_{IN} demanded by the combination of the system load 20 and the charge control unit 12 or by the combination of the system load 20, the chargeable power source 22 and the charge control unit 12 exceeds that which can be produced by the AC adapter 16, will be that (but less than I_{M}) at which the output voltage, V_{OA}, intersects the boundary of the characteristic current-voltage curve 55 of the particular AC adapter 16. The PWM controller 40 controls PWMI under such conditions in a conventional manner to thereby control the output current I_{OA} of the AC adapter 16 to such a magnitude. The PWM controller 40 also controls PWMC under such conditions to partition I_{OUT} produced by the charge control unit 12 into appropriate magnitudes of I_{L} and I_{CH}.

In contrast to the conventional charge control systems just described, and referring now to FIG. 5, a plot 56 of output power produced by an example AC adapter 16 vs. the output voltage, V_{OA}, produced by such an AC adapter 16 is shown. Superimposed on this plot is the input voltage, V_{IN}, received by the APM unit 52 of FIG. 3. As illustrated by the double-headed arrow 57 in FIG. 5, the APM unit 52 is operable to dynamically vary the reference control signal V_{R} (or V_{IR}) in a manner that ultimately produces a value of V_{R} (or V_{IR}) which corresponds to the maximum value, MP, of output power that can be produced by the AC adapter 16. More specifically, the APM unit 52 is responsive in one illustrative embodiment to the input current and voltage, V_{IN} and V_{IIN}, respectively corresponding to the output current, I_{OA}, and the output voltage, V_{OA}, respectively of the AC adapter 16, to dynamically modify the magnitude of the reference control signal V_{R}. The IDPM unit 54 is, in turn, responsive in a conventional manner to V_{R} to produce corresponding control signals to which the PWM controller 40 is, in turn, responsive in a conventional manner to control PWMV such that the input voltage, V_{IN}, (i.e., the output voltage, V_{OA} produced by the AC adapter 16) is controlled (e.g., via switch S2) to the magnitude V_{R}. The APM unit 52 illustratively implements an algorithm which continually varies V_{R} such that a magnitude of V_{R} is reached at which the output power produced by the AC adapter 16 is at a maximum (i.e., the magnitude MP as illustrated in FIG. 5). As described above, under such conditions in which the input current I_{IN} demanded by the combination of the system load 20 and the charge control unit 12 or by the combination of the system load 20, the chargeable power source 22 and the charge control unit 12 exceeds that which can be produced by the AC adapter 16, the output current, I_{OA}, produced by the AC adapter 16 will be that (but less than I_{M}) at which the output voltage, V_{R} (V_{IN}), intersects the boundary of the characteristic current-voltage curve 55 of the particular AC adapter 16, which point will correspond to the maximum power, MP, which can be produced under such conditions by the AC adapter 16. The PWM controller 40 controls PWMI under such conditions in a conventional manner to thereby control the output current I_{OA} of the AC adapter 16 to such a magnitude. The PWM controller 40 also controls PWMC under such conditions to partition I_{OUT} produced by the charge control unit 12 into appropriate magnitudes of I_{L} and I_{CH}.

In some alternative embodiments, the magnitude of the reference control signal, V_{R}, produced by the APM unit 52 may be proportional to the output voltage, V_{OA}, at which the AC adapter 16 produces maximum output power, and in such embodiments the IDPM unit 54 may be configured to be responsive to such a magnitude of V_{R} to produce appropriate control signals to which the PWM controller 40 is responsive to control PWMV such that V_{OA} produced by the AC adapter 16 results in maximum power output by the AC adapter 16 under such operating conditions. Any modifications to the IDPM unit 54 required for such alternative operation would be a mechanical step for a skilled artisan.

In other alternative embodiments, the reference control signal produced by the APM unit 52 may be V_{IR}, and the IDPM unit 54 may in such embodiments be configured to produce control signals to which the PWM controller 40 is responsive to control PWMI such that I_{OA} produced by the AC adapter 16 is the magnitude of output current at which the maximum output power is produced (i.e., the magnitude MP as illustrated in FIG. 5). As described above, under such conditions in which the input current I_{N} demanded by the combination of the system load 20 and the charge control unit 12 or by the combination of the system load 20, the chargeable power source 22 and the charge control unit 12 exceeds that which can be produced by the AC adapter 16, the output voltage, V_{OA}, produced by the AC adapter 16 will be that which intersects the boundary of the characteristic current-voltage curve 55 of the particular AC adapter 16 at the output current I_{OA} defined by V_{IR}. The PWM controller 40 can then control PWMV under such conditions in a conventional manner to thereby control the output current V_{OA} to such a magnitude. The PWM controller 40 can also control PWMC under such conditions to partition I_{OUT} produced by the charge control unit 12 into appropriate magnitudes of I_{L} and I_{CH}. Any modifications to the IDPM unit 54 and/or to the PWM controller 40 in such alternative embodiments would be a mechanical step for a skilled artisan.

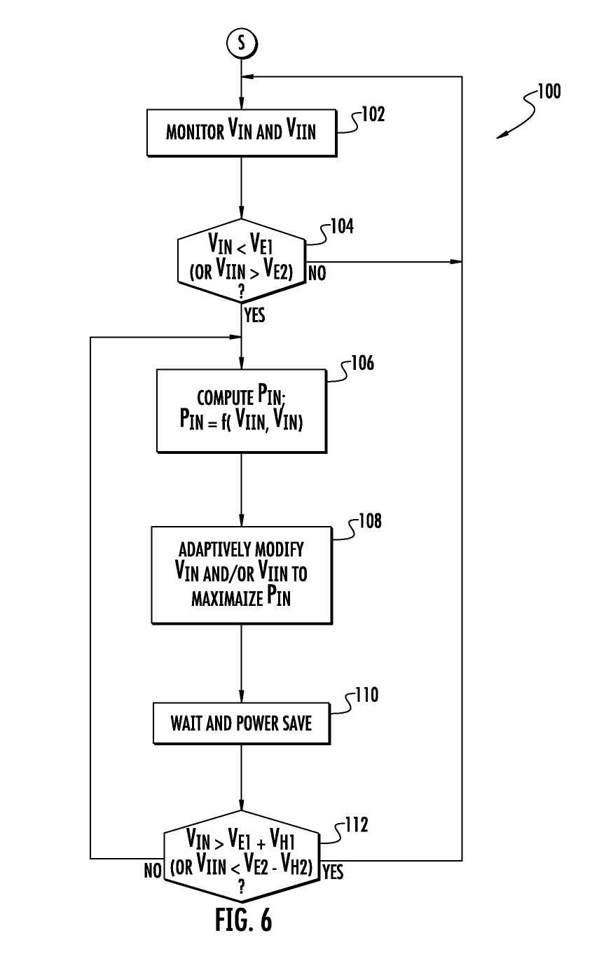

Referring now to FIG. 6, a flowchart is shown of one illustrative process 100 executed by the APM unit 52, and also the IDPM unit 54 and PWM controller 40, for maximizing output power produced by the AC adapter under the operating conditions described above, i.e., in which the input current I_{IN} demanded by the combination of the charge control unit 12 and the system load 20 or by the combination of the charge control unit 12, the system load 20 and the chargeable power source 22 exceeds that which can be produced by the AC adapter 16. In one illustrative embodiment, the APM unit 52 is implemented in the form of purely analog circuitry, and in such an embodiment the process 100 illustrated in FIG. 6 represents an algorithm executed by such analog circuitry. In embodiments which may include one or more conventional processor circuits, e.g., one or more microprocessors, signal processors or the like, the process 100 may be implemented, at least in part, in the form of one or more software algorithms stored in a memory and executable by the processor circuit to carry out, at least in part, the process 100.

The process 100 will, for purposes of description, be described as being implemented and executed by the APM unit 52, the IDPM unit 54 and the PWM controller 40 as just described with respect to FIG. 5. In any case, the process 100 begins at step 102 where the APM unit 52 monitors the input voltage, V_{IN}, and the input current signal, V_{IIN}, corresponding to the output voltage, V_{OA}, and the output current, I_{OA}, produced by the AC adapter 16. Thereafter at step 104, the APM unit 52 determines whether V_{IN} is less than a predefined voltage value, V_{E1}, or in the alternative whether V_{IIN} is greater than another predefined voltage value, V_{E2}. Illustratively, V_{E1} is a value or magnitude of the output voltage, V_{OA}, produced by the AC adapter 16 which is sufficiently below the relatively constant magnitude of output voltage V_{OA} produced by the AC adapter 16 when the output current is less than the rated current, I_{RA}, (see, e.g., FIG. 4) to indicate that the magnitude of the output current, I_{OA}, demanded by the combination of the charge control unit 12 and the system load 20 or by the combination of the charge control unit 12, the system load 20 and the chargeable power source 22 is greater than that which can be produced by the AC adapter 16. In one example embodiment in which the relatively constant value of V_{OA} (below I_{RA}) is typically 5.0 volts, V_{E1} may be, for example, set to 4.75 volts, although other values of V_{E1} are contemplated by this disclosure. On the other hand, in embodiments in which the reference control signal is V_{R}, V_{E2} illustratively corresponds to a value or magnitude of the output current, I_{OA}, produced by the AC adapter 16 which is sufficiently above the rated current, I_{RA}, to indicate that the magnitude of the output current, I_{OA}, demanded by the combination of the charge control unit 12 and the system load 20 or by the combination of the charge control unit 12, the system load 20 and the chargeable power source 22 is greater than that which can be produced by the AC adapter 16. In either case, the “NO” branch of step 104 returns the process to step 102, and the “YES” branch of step 104 advances to step 106 where the APM unit 52 is operable to compute the input power, P_{IN}, as a well-known function of V_{IIN} and V_{IN}, e.g., P_{IN}=K*V_{IIN}*V_{IN}, where K is a constant set to a value which translates V_{IIN} to the actual value of I_{IN}. The input power, P_{IN}, is of course the output power produced by the AC adapter 16, and step 106 advances to step 108 where the APM unit 52, the IDPM unit 54 and the PWM controller 40 are together operable to adaptively modify V_{IN} and/or V_{IIN} as discussed hereinabove with respect to FIG. 5 to maximize P_{IN}. Thereafter at step 110, the APM unit 52 is operable to wait for a predetermined time period and, during this waiting period, to conserve power consumed by the APM unit 52 by shutting down all or most of the circuitry internal to the APM unit 52. Thus, during the waiting time period of step 110, little or no electrical power is consumed by the APM unit 52, thereby conserving electrical power when operation of the APM unit 52 is not needed. Thereafter at step 112, the APM unit 52 is operable to compare V_{IN} to V_{E1}+V_{H1}, or to compare V_{IIN} to V_{E2}−V_{H2}, where V_{H1} and V_{H2} represent predefined hysteresis voltage values. Thus, if V_{IN} has not increased by at least V_{H1} above V_{E1} (or if V_{IIN} has not decreased by at least V_{H2} below V_{E2}), the process 100 loops back to step 106. Otherwise, the process loops back to step 102 to restart the process 100. It will be understood that, regardless of whether the reference control signal is V_{R} or V_{IR}, either or both of V_{IN} and V_{IIN} may be evaluated to determine whether the process 100 should advance from step 104 to step 106, i.e., to activate the APM unit 52, and/or to determine whether the process 100 should exit from steps 106 and 108, i.e., whether to deactivate or otherwise discontinue operation of the APM unit 52.

In any case, the Input Dynamic Power Management (IDPM) unit 54 is responsive in a conventional manner to the reference control signal to produce control signals from which the PWM controller 40 controls the duty cycle of the control signal PWMI or PWMV in a manner that controls the switches S1 or S2 respectively to draw from the AC adapter 16 an input current, I_{IN} (corresponding to the output current, I_{OA}, of the AC adapter 16), or an input voltage, V_{IN}, (corresponding to the output voltage, V_{OA}, of the AC adapter 16), that corresponds to the maximum available output power, M, that can be produced by the AC adapter 16. By so controlling the switching circuitry of the charge control unit 12, the maximum output power that can be produced by the AC adapter 16 is supplied to the input of the charge control unit 12. Via conventional control of the device S3 in combination with the diode D1, electrical power required by the system load 20 is provided thereto, and all remaining electrical power is applied to the rechargeable power source 22 for recharging thereof. In this manner, all output power available from the AC adapter 16 that is not used by the combination of the system load 20 and the charge controller 12 is used to recharge the rechargeable power source 22, thereby maximizing the recharging current/voltage and minimizing charge time under such conditions.

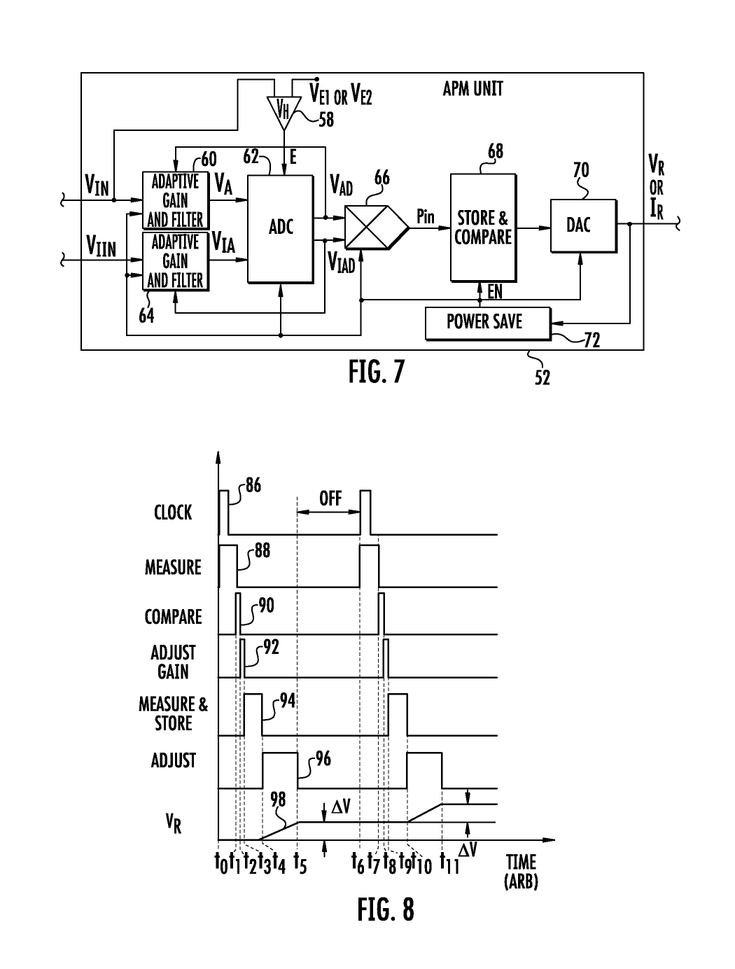

Referring now to FIG. 7, a block-diagram is shown of one illustrative embodiment of the Adaptive Power Management (APM) unit 52 illustrated in FIG. 3. In the illustrated embodiment, the APM unit 52 includes a comparator 58 having one input receiving the input voltage, V_{IN}, and another input receiving an enable voltage, V_{E1} or V_{E2}. In one embodiment, the enable voltage, V_{E1}, is used and is illustratively set to the static, i.e., constant, voltage value, V_{E}, illustrated and described with respect to FIG. 4. It will be understood, however, V_{E2}, may alternatively be used and in either case the enable signal, V_{E1} or V_{E2}, may alternatively be a dynamic signal. The comparator 58 is illustratively designed to have some amount of switching hysteresis such that the comparator 58 produces an active enable signal, E, when the input voltage, V_{IN}, drops below V_{E1} and switches to produce an inactive enable signal, E, i.e., to deactivate the enable signal, E, when the input voltage, V_{IN}, increases to a voltage greater than the sum of V_{E} and the hysteresis voltage, V_{H1}. Alternatively, the comparator 58 may be configured to produce an active enable signal, E, when the input current signal, V_{IIN}, increases above V_{E2} and switches to produce an inactive enable signal, E, i.e., to deactivate the enable signal, E, when the input current signal, V_{IIN}, decreases to a voltage less than the difference of V_{E2} and the hysteresis voltage, V_{H2}.

The APM unit 58 further includes an adaptive gain and filter circuit 60 which receives at one input the input voltage, V_{IN}, (i.e., corresponding to the output voltage of the AC adapter 16) and which produces as an output an adjusted voltage, V_{A}. The adjusted voltage, V_{A}, is provided to one input of a conventional analog-to-digital converter (ADC) circuit 62. Another adaptive gain and filter circuit 64 receives at one input the input current signal, V_{IIN,} (i.e., a voltage signal having a value which corresponds to the output current of the AC adapter 16) and produces as an output an adjusted current signal, V_{IA}, which is illustratively a voltage signal having a value corresponding to the output current of the AC adapter 16 adjusted by the adaptive gain and filter circuit 62. The adjusted current signal V_{IA} is provided to another input to the ADC circuit 62. The ADC circuit 62 is operable in a conventional manner to convert the adjusted analog signals V_{A} and V_{IA} to digital signals V_{AD} and V_{IAD} produced at separate respective outputs of the ADC circuit 62. The V_{AD} output of the ADC circuit 62 is provided to one input of a conventional digital multiplier circuit 66 and also to another input of the adaptive gain and filter circuit 60. The V_{IAD} output of the ADC circuit 62 is provided to another input of the digital multiplier circuit 66 and also to another input of the adaptive gain and filter circuit 64. In one illustrative embodiment, the ADC circuit 62 is a 10-bit analog-to-digital converter such that the full count range is 1024 (e.g., 2¹⁰), although the ADC circuit 62 may alternatively have more or fewer bits of resolution.

The ADC circuit 62 illustratively receives as another input the enable signal, E, produced by the comparator 58, and the ADC circuit 62 is therefore operable to convert analog signals to digital signals only when the enable signal, E, is activated, e.g., when the value of V_{IN} is sufficiently less than the value of V_{E1} so as to cause E to assume its activated state or is sufficiently greater than the value of V_{E2} so as to cause E to assume its activated state. Conversely, when the enable signal, E, is deactivated, e.g., when the value of V_{IN} is sufficiently greater than the value of V_{E1} so as to cause E to assume its deactivated state or when the value of V_{IIN} is sufficiently less than the value of V_{E2} so as to cause E to assume its deactivated state, the ADC circuit 62 is disabled and therefore not operable to convert analog signals to digital signals. Under such conditions, the output of the APC unit 50 should not affect operation of the adaptive charge controller 28 as the adaptive charge controller 28 will under such conditions be in an operating mode controlled by one of the other operating mode controlling units 42-48. The outputs of the ADC circuit 62 under such conditions may therefore be set to a default value that causes the output, V_{R} (or V_{IR}) of the ADM unit 52 to have no affect on the operation of the IDPM unit 54 and/or that causes the output of the IDPM unit 54 to have no affect on the operation of the adaptive charge controller 28.

The filter portion of each adaptive gain and filter circuit 60, 64 is illustratively provided to remove any noise or ripple that the analog input signal(s) V_{IN} and/or V_{IIN} may contain. In this regard, the filter portion in one illustrative embodiment of each adaptive gain and filter circuit 60, 64 is a conventional low-pass filter. However, this disclosure contemplates that the filter portions of the adaptive gain and filter circuits 60, 64 may alternatively or additionally include one or more other known types of signal filtering circuits. Illustratively, the filter portion of each adaptive gain and filter circuit 60, 64 is located at the front end of each circuit 60, 64 such that any gain applied by the circuits 60, 64 is applied to the filtered signal(s). By way of designation, the filtered analog input signals will be referred to herein as F(V_{IN}) and F(V_{IIN}) respectively.

The adaptive gain portion of each adaptive gain and filter circuit 60, 64 is illustratively configured to apply (e.g., as a multiplier) an adaptively determined gain to the filtered analog input signals F(V_{IN}) and F(V_{IIN}) such that each resulting adjusted analog signal V_{A}, V_{IA} has a value that falls within a window defined by predefined low and high values. For purposes of illustrating operation of the adaptive gain and filter circuits 60, 64, the gain applied by the adaptive gain and filter circuit 60 to the filtered analog signal F(V_{IN}) will be designated herein as G₆₀ and the gain applied by the adaptive gain and filter circuit 64 to the filtered analog signal F(V_{IIN}) will be designated herein as G₆₄. Thus, in accordance with these designations, V_{A}=G₆₀*F(V_{IN}) and V_{IA}=G₆₄*F(V_{IIN}).

Each of the adaptive gain and filter circuits 60, 64 is illustratively designed to compare the respective output of the ADC circuit 62 with the predefined low and high values, and to lower the value of its gain if the value of the respective output of the ADC circuit 62 is greater than the predefined high value and to raise the value of its gain if the value of the respective output of the ADC circuit 62 is less than the predefined low value. It will be understood that one or both of the low and high values used for the adaptive gain and filter circuit 60 may or may not be the same as those used for the adaptive gain and filter circuit 64, and that this disclosure contemplates that such low and high values may be selected in various different ways. It will further be understood that the circuits 60, 64 may be configured to raise and lower its respective gain value by the same or different amount, and that within each circuit the amount by which the gain is raised may or may not be the same as the amount by which the gain is lowered. This disclosure contemplates that the amount by which either or both of the circuits 60, 64 raises and/or lowers its respective gain value may vary between applications.

In one illustrative example of the adaptive gain portions of the adaptive gain and filter circuits 60, 64, the predefined low value for each circuit 60, 64 is 25% of the full range of the ADC circuit 62 (i.e., the maximum count value of the ADC circuit 62) and the predefined high value for each circuit 60, 64 is 75% of the full range of the ADC circuit 62, and the amount by which each gain value G₆₀ and G₆₄ is raised or lowered is ½ of the current gain value. Using as an example a 10-bit ADC circuit 62, the full range of such an ADC circuit 62 is 1024. The predefined low value is therefore (0.25*1024)=256, and the predefined high value is (0.75*1024)=768. In this example implementation of the adaptive gain and filter circuits 60, 64, each circuit 60, 64 thus operates identically by comparing the count value of V_{A} and V_{IA} respectively to 256 and 768. If the count value of V_{A} is less than 256, the gain value G₆₀ is doubled (e.g., G₆₀=2*G₆₀), and if the count value of V_{IA} is less than 256 the gain value G₆₄ is likewise doubled (e.g., G₆₄=2*G₆₄). If the count value of V_{A} is instead greater than 768, the gain value G₆₀ is halved (e.g., G₆₀=G₆₀/2), and if the count value of V_{IA} is greater than 768 the gain value G₆₄ is likewise halved (e.g., G₆₄=G₆₄/2). If instead either count value V_{A} or V_{IA} is between 256 and 768, the corresponding gain value G₆₀ or G₆₄ respectively is not changed. This process continues until both V_{A} and V_{IA} are between the predefined low and high values, e.g., 256 and 768 respectively. It will be understood that this particular implementation is provided only by way of example, and should not be considered to be limiting in any way.

The digital multiplier circuit 66 may be conventional and is operable to multiply the digital signal V_{AD} and V_{IAD} to produce at an output of the multiplier circuit 66 an input power, P_{IN}=V_{AD}*V_{IAD}, which represents the electrical power received by the charge control unit 12 (i.e., the electrical power produced by the AC adapter 16). The input power, P_{IN}, is provided as an input to a store and compare circuit 68. The store and compare circuit 68 illustratively includes a one or more memory registers which store therein the most recent value of the input power, P_{IN}. The store and compare circuit 68 further includes conventional comparison circuitry, e.g., one or more conventional comparators, configured to compare the current value of the input power, P_{IN}, with the stored value of P_{IN}. The store and compare circuit 68 further includes conventional circuitry which determines a step value, e.g., a step size based on the difference between the current and stored values of P_{IN}, and a direction, e.g., one of two values based on whether the current value of P_{IN} is greater or less than the stored value of P_{IN}. The step value determination may or may not be weighted, and may be a simple arithmetic difference or include a more complex difference determination. In any case, the step and direction values produced at an output of the store and compare circuit 68 are provided as an input to a conventional digital-to-analog converter (DAC) circuit 70 which converts the current step and direction values to a current value of the reference control signal, e.g., reference control voltage, V_{R}, or reference control current, I_{R}, e.g., in the form a voltage V_{IR} as described hereinabove with respect to FIG. 3.

The IDPM circuit 54 is illustratively responsive to the reference control signal, V_{R} or V_{IR}, to produce control signals from which the PWM controller 40 controls the duty cycle of the control signals PWMI and/or PWMV as described hereinabove. Under conditions in which the electrical power demanded by the system load 20 or the combination of the system load 20 and the chargeable power source 22 is greater than that which can be produced by the AC adapter, controlling one or the other of V_{IN} and I_{IN} in this manner will necessarily cause the AC adapter 16 to produce the other of V_{IN} or I_{IN} in accordance with the particular characteristics of the AC adapter 16 being used, thereby controlling the input power to the charge control unit 12 (i.e., the output power produced by the AC adapter 16) to its maximum value. Illustratively, the DAC circuit 70 is configured using conventional circuitry to produce the reference control signal (V_{R} or V_{IR}) in a manner that gradually implements changes in the step value.

The store and compare circuit 68 is illustratively configured to determine the step value in accordance with one or more conventional input power maximization algorithms. In one embodiment, for example, the store and compare circuit 68 is configured to determine the step value using a conventional maximum power point tracking (MPPT) algorithm designed to move V_{R} (or V_{IR}) to a value which maximizes the input power, P_{IN}, (i.e., the output power produced by the AC adapter 16). In one specific embodiment, the MPPT algorithm is illustratively implemented in the form of a conventional perturb-and-observe method, although this disclosure contemplates other embodiments in which the MPPT algorithm may be alternatively or additionally implemented using one or more other conventional MPPT algorithms such as a conventional incremental conductance method, a constant voltage method, or the like. Those skilled in the art will recognize that any modifications required to implement any such additional or alternate MPPT algorithm(s) would be a mechanical step for a person of ordinary skill in the art to which this disclosure pertains. In still other embodiments, the store and compare circuit 68 may alternatively be configured to determine the step value in accordance with other conventional maximum value determining techniques, examples of which may include, but are not limited to, one or more numerical hunting techniques, one or more conventional iterative techniques, or the like.

In one embodiment, at least the APM unit 52, including the maximum power value determining algorithm, is illustratively implemented entirely using analog circuitry. In another embodiment, the entire charge control unit 12 is implemented entirely using analog circuitry, and in still another embodiment the adaptive charge controller 28 is an entirely analog circuit fabricated on a single, monolithic integrated circuit (or “chip”). The structures and techniques described herein for extracting maximum electrical power from the AC adapter 16 are applicable to a wide range of electrical power sources including, but not limited to, solar panels and AC adapters having different voltage, current and/or power ratings than those described herein.

Referring now to FIG. 8, a timing diagram is shown illustrating operation of one illustrative embodiment of the APM unit 52 of FIG. 5. It will be understood that the timing diagram of FIG. 7 illustrates only one actual signal produced by the APM unit 52; the reference control signal, V_{R}, and that the remaining timing waveforms illustrated in FIG. 7 do not represent signals per se but rather events carried out by the APM unit 52. FIG. 7 is arranged in this manner to show the timing of the events carried out by the APM unit 52 relative to resulting changes in value of the reference control signal, V_{R}, for the purpose of illustrating a power-saving feature implemented in the adaptive charge controller 28. In this regard, low-to-high (or high-to-low) transitions in a CLOCK timing waveform 86 represent beginnings of each complete set of events carried out by the APM unit 52. A complete set of events carried out by the APM unit 52 is illustrated in FIG. 8 by a combination of the V_{R} signal 98 and a number of event waveforms, including a MEASURE waveform 88, a COMPARE waveform 90, an ADJUST GAIN waveform 92, a MEASURE & STORE waveform 94 and an ADJUST waveform 96, relative to a dimensionless time scale. A first complete set of events begins, for example, at time t₀ where CLOCK 86 and MEASURE 88 both transition from low-to-high, which signals the measurement, e.g. by the adaptive gain and filter circuits 60 and 64, of the input voltage and current, V_{IN} and V_{IIN} respectively. Over the duration of MEASURE 88, V_{IN} and V_{IIN} are passed through the adaptive gain and filter circuits 60, 64 such that V_{IN} and V_{IIN} are each filtered and then multiplied by corresponding gain values (e.g., with G₆₀ and G₆₄ both set to 1 for the first pass), the ADC circuit 62 converts the resulting V_{A} to V_{AD} and V_{IA} to V_{IAD}, and the digital multiplier 66 then computes P_{IN}, all as described hereinabove. At time t₁, MEASURE 88 transitions from high-to-low and COMPARE 90 transitions from low-to-high, during which the store and compare circuit 68 compares P_{IN} to the previous value of P_{IN} stored in the one or more memory registers of the store and compare circuit 68 to determine the step value and direction of change of V_{R} as described above. For the first set of events, the stored value of P_{IN} may be, for example, but not limited to, a previously stored P_{IN} value, a default power value or the current value of P_{IN}. Thereafter at time t₂, COMPARE 90 transitions from high-to-low and ADJUST GAIN 92 transitions from low-to-high, during which the adaptive gain and filter circuits 60 and 64 adjust the gain value(s) G₆₀ and/or G₆₄ if required as described above. Thereafter at time t₃, ADJUST GAIN 92 transitions from high-to-low and MEASURE & STORE transitions from low-to-high, during which the adaptive gain and filter circuits 60 and 64 measure the input voltage and current, V_{IN} and V_{IIN} respectively, V_{IN} and V_{IIN} are passed through the adaptive gain and filter circuits 60, 64 such that V_{IN} and V_{IIN} are each filtered and then multiplied by corresponding (and possibly adjusted) gain values G₆₀ and G₆₄ respectively, the ADC circuit 62 then converts the resulting V_{A} to V_{AD} and V_{IA} to V_{IAD}, the digital multiplier 66 then computes P_{IN}, and the store and compare circuit 68 then compares the current P_{IN} to the previous value of P_{IN} stored in the one or more memory registers of the store and compare circuit 68 to determine the step value and direction of change of V_{R}. Thereafter at time t₄, MEASURE & STORE 94 transitions from high-to-low and ADJUST 96 transitions from low-to-high, during which the DAC circuit 70 converts the step value and direction to an analog signal, e.g., a voltage signal in this example, and adds this voltage signal to the current value of V_{R}, which then causes V_{R} 98 to change in response. In the example illustrated in FIG. 8, V_{R} 98 changes by increasing in value, e.g., by an amount ΔV₁, during the time duration t₄ to t₅. At time t₅, V_{R} 98 has ceased changing and ADJUST 96 thus transitions from high-to-low.

The time t₅ ends the first complete set of events carried out by the APM unit 52. Referring again to FIG. 7, the APM unit 52 further includes a power save circuit 72 which illustratively receives as an input the reference control voltage V_{R}, and which produces as an output an enable signal, EN. The enable signal EN is provided to an enable input of each of the adaptive gain circuits 60, 64, the ADC 62, the multiplier circuit 66, the store and compare circuit 68 and the DAC 80. Illustratively, the power save circuit 72 monitors the reference control voltage V_{R}, and during t₁-t₄, i.e., when V_{R} is not being adjusted, the enable signal EN is set to an operating enable value, e.g., logic high or logic low, such that the circuits 60, 62, 64, 66, 68 and 70 of the APM unit 52 are fully operational. When V_{R} reaches a constant or otherwise stable voltage level, e.g., ΔV illustrated in FIG. 8, after being modified during the ADJUST time period, e.g., between t₄ and t₅, the power save circuit 72 changes the value of EN, e.g., to logic low or logic high, to set EN to a circuit disable value. In the embodiment of the APM unit 52 illustrated in FIG. 7, the circuits 60, 62, 64, 66, 68 and 70 are responsive to the circuit disable value of EN to enter a stand-by mode. Illustratively, the stand-by mode for the circuits 60, 62, 64 and 66 is a shut down mode in which these circuits 60, 62, 64 and 66 completely power down such that they do not consume any current. The shut down mode of the circuits 68 and 70 is illustratively a sleep mode in which they consume only enough current to maintain valid, i.e., stored and current, data. Thus, in response to a detected constant or otherwise stable value of V_{R}, the power save circuit 72 disables the APM unit 52, e.g., by turning off or disabling electrical power to some or all of the remaining circuits of the APM unit 52 during the time interval t₅ to t₆ to thereby conserve power during this time interval. After a predefined waiting time period, i.e., between t₅ and t₆, the power save circuit 72 again changes the value of EN, e.g., to logic high or logic low, to reset EN to the circuit enable value at the time t₆. The time t₆ begins a new complete set of events carried out by the APM unit 52, and the events described between t₀-t₆ begin again and are carried out as just described between t₆ and t₁₁, and repeat thereafter as long as the APM unit 52 is activated.

While one or more embodiments have been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A charger, comprising:
an input,
at least one switch having a first node coupled to a reference voltage,
a current sensor coupled between the input and a second node of the at least one switch,
an output coupled to a third node of the at least one switch, and
a charge controller coupled to the input and configured to determine an input voltage, coupled to the current sensor and configured to determine an input current and coupled to control inputs of the at least one switch, the at least one switch responsive to control signals supplied by the charge controller to the control inputs thereof to control voltage and current at the output of the charger, the charge controller configured to produce the control signals in response to the input voltage and the input current in a manner that approximately maximizes electrical power drawn at the input.

2. The charger of claim 1 further comprising a filter coupled between the output and the third node of the at least one switch.

3. The charger of claim 1 wherein the charger controller has a plurality of operating modes including a dynamic power management mode during which electrical power demand at the input exceeds electrical power available at the input, the charge controller configured in the dynamic power management mode to produce the control signals based on a reference control signal,
and wherein the charge controller comprises an adaptive power management unit which is configured to produce the reference control signal, the adaptive power management unit configured to respond to the input voltage and the input current by varying the reference control signal in a manner that approximately maximizes electrical power drawn at the input.

4. The charger of claim 3 wherein the adaptive power management unit comprises:
a first analog adaptive gain circuit having an input receiving the input voltage and an output producing an adjusted voltage as a product of the input voltage and a first gain value,
a second analog adaptive gain circuit having an input receiving the input current and an output producing an adjusted current as a product of the input current and a second gain value,
a first converter for converting the adjusted voltage to a discrete voltage value and converting the adjusted current to a discrete current value,
a multiplier circuit for producing an input power value as a product of the discrete voltage value and the discrete current value,
a comparison circuit for producing a step value proportional to a difference between the input power value and a previously determined input power value, and
a second converter for converting the step value to the reference control signal.

5. The charger of claim 4 wherein the first analog adaptive gain circuit is responsive to the discrete voltage value to adjust the first gain value such that the discrete voltage value is between predefined low and high values.

6. The charger of claim 4 wherein the second analog adaptive gain circuit is responsive to the discrete current value to adjust the second gain value such that the discrete current value is between predefined low and high values.

7. The charger of claim 4 wherein the first and second analog adaptive gain circuits each comprise analog signal filtering circuitry.

8. The charger of claim 4 wherein the comparison circuitry includes one or more memory registers for storing the input power value therein for comparison with a subsequently determined input power value.

9. The charger of claim 1 wherein the charge control controller is fabricated entirely using analog circuitry.

10. A charging system, comprising:
an adapter for converting AC electrical power to a DC electrical power, wherein a DC voltage produced by the adapter decreases rapidly as a DC current produced by the adapter increases above a rated current value,
an electronic device having a power input coupled to at least one electrically chargeable source and to at least one electrical circuit defining a system load, and
a charge control unit having an input coupled to the adapter, an output coupled to the power input of the electronic device, a sensor for sensing the DC current produced by the adapter and producing a current-sense signal, and switching circuitry coupled between the charge control unit input and output and responsive to control signals produced by the charge control unit to controllably supply the DC voltage and the DC current from the adapter to the charge control unit, the charge control unit responsive to the DC voltage produced by the adapter and to the current signal, when the DC current demanded by the electronic device exceeds the rated current to produce the control signals in a manner that approximately maximizes the DC electrical power produced by the adapter.

11. The charging system of claim 10 wherein the charge control unit is responsive to the DC voltage produced by the adapter and to the current signal, when the DC voltage produced by the adapter drops below a predefined voltage value following demand by the charge control unit of DC current in excess of the rated current, to produce the control signals in a manner that maximizes the DC electrical power produced by the adapter.

12. The charging system of claim 10 wherein the charge control unit comprises a charge controller producing the control signals, the charge controller having a plurality of operating modes including a dynamic power management mode during which the DC current demanded by the charge control unit exceeds the rated current, the charge controller operable in the dynamic power management mode to produce the control signals based on a reference control signal,
and wherein the charge controller comprises an adaptive power management unit which produces the reference control signal, the adaptive power management unit responsive to the DC voltage produced by the adapter and to the current signal to vary the reference control signal in a manner that maximizes the DC electrical power produced by the adapter.

13. The charging system of claim 12 wherein the adaptive power management unit comprises:
a first analog adaptive gain circuit having an input receiving the DC voltage produced by the adapter and an output producing an adjusted voltage as a product of the DC voltage produced by the adapter and a first gain value,
a second analog adaptive gain circuit having an input receiving the current signal and an output producing an adjusted current as a product of the current signal and a second gain value,
a first converter for converting the adjusted voltage to a discrete voltage value and converting the adjusted current to a discrete current value,
a multiplier circuit for producing an input power value as a product of the discrete voltage value and the discrete current value,
a comparison circuit for producing a step value proportional to a difference between the input power value and a previously determined input power value, and
a second converter for converting the step value to the reference control signal.

14. The charging system of claim 13 wherein the first analog adaptive gain circuit is responsive to the discrete voltage value to adjust the first gain value such that the discrete voltage value is between predefined low and high values,
and wherein the second analog adaptive gain circuit is responsive to the discrete current value to adjust the second gain value such that the discrete current value is between the predefined low and high values.

15. A method of supplying DC electrical power from an adapter to an electronic device, the adapter converting AC current and voltage to DC current and voltage, wherein the DC voltage produced by the adapter decreases rapidly as the DC current produced by the adapter increases above a rated current value, the method comprising:
monitoring one of the DC voltage and the DC current produced by the AC adapter, and
if the one of the monitored DC voltage drops below a predefined voltage and the monitored DC current exceeds the rated current, adaptively controlling a level of at least one of the DC voltage and the DC current supplied by the adapter to the electronic device in a manner that approximately maximizes the DC electrical power supplied by the adapter.

16. The method of claim 15 wherein adaptively controlling a level of at least one of the DC voltage and the DC current supplied by the adapter to the electronic device comprises:
repeatedly executing the steps of:
measuring the DC current supplied by the adapter and producing an analog current signal corresponding thereto,
sampling the DC voltage and the analog current signal,
computing a supply power as a function of the sampled DC voltage and the sampled analog current signal,
determining a tracking direction toward the greater of the supply power and a most recent previous supply power value stored in memory,
adjusting a reference control signal based on the tracking direction, and
controlling the level of the at least one of the DC voltage and the DC current supplied by the adapter to the electronic device based on the reference control signal.

17. The method of claim 16 further comprising:
amplifying the DC voltage produced by the adapter by a voltage gain value, and
amplifying the analog current signal by a current gain value,
and wherein sampling the DC voltage and the analog current signal comprises sampling the amplified DC voltage and the amplified analog current signal.

18. The method of claim 17 further comprising, prior to adjusting a reference control signal:
if the sampled DC voltage is not between predetermined low and high values, repeatedly modifying the voltage gain value as a function of the sampled DC voltage and sampling the DC voltage amplified by the modified voltage gain value until the value of the sampled DC voltage is between the predetermined low and high values,
if the sampled analog current signal is not between the predetermined low and high values, repeatedly modifying the current gain value as a function of the sampled analog current signal and sampling the analog current signal amplified by the modified current gain value until the value of the sampled analog current signal is between the predetermined low and high values,
computing a previous supply power value as a function of the most recently sampled DC voltage and the most recently sampled analog current signal, and
storing the previous supply power value in memory.

19. The method of claim 17 wherein the method further comprises delaying for a predefined time period between each iteration of execution of the combination of measuring the DC current, amplifying the DC voltage, amplifying the analog current signal, sampling the amplified DC voltage and the amplified analog current signal, computing the supply power, determining the tracking direction and adjusting the reference control signal.

20. The method of claim 19 further comprising an adaptive power management circuit including electrical circuitry for amplifying the DC voltage, for amplifying the analog current signal, for sampling the amplified DC voltage and the amplified analog current signal, for computing the supply power, for determining the tracking direction, and for adjusting the reference control signal,
and wherein the method further comprises shutting down the adaptive power management circuit during the predefined time period to conserve electrical power use by the adaptive power management circuit during the predefined time period.
